(19) United States
(12) Patent Application Publication
(10) Pub. No.: US 2025/0379207 A1
(43) Pub. Date: Dec. 11, 2025

(54) ELECTRODE SHEET AND METHOD FOR MANUFACTURING THE SAME

(71) Applicant: TOYOTA JIDOSHA KABUSHIKI KAISHA, Aichi (JP)

(72) Inventors: Masashi UEDA, Toyota-shi (JP); Nariaki MIKI, Okazaki-shi (JP); Tomoko HIGO, Toyota-shi (JP)

(21) Appl. No.: 19/220,106

(22) Filed: May 28, 2025

(30) Foreign Application Priority Data
Jun. 11, 2024 (JP) 2024-094609

(51) Int. Cl. H01M 4/04; H01M 4/02; H01M 4/131; H01M 4/1391; H01M 4/36; H01M 4/505; H01M 4/525; H01M 4/62

(52) U.S. Cl. CPC H01M 4/0435; H01M 4/131; H01M 4/1391; H01M 4/366; H01M 4/505; H01M 4/525; H01M 4/623; H01M 4/625; H01M 2004/021

(57) ABSTRACT

A method for manufacturing an electrode sheet is disclosed. The method may include producing first coated active material particles by mixing first active material particles with at least a binder; producing second coated active material particles by mixing second active material particles with at least a conduction aid; producing an electrode mixture by mixing the first coated active material particles with the second coated active material particles; and forming the electrode mixture into a sheet shape. An average particle diameter of the second active material particles may be larger than an average particle diameter of the first active material particles.

### REFERENCE TO RELATED APPLICATIONS

This application claims priority from Japanese Patent Application No. 2024-094609 filed on Jun. 11, 2024. The entire content of the priority application is incorporated herein by reference.

### BACKGROUND ART

The technology disclosed herein relates to an electrode sheet and a method of manufacturing the same.

Japanese Unexamined Patent Application Publication No. 2021-504877 (JP 2021-504877 A) describes an electrode sheet for a battery cell and a method for manufacturing the same. The electrode sheet includes active material particles and a binder. The method of manufacturing the electrode sheet includes a step of producing an electrode mixture by mixing the active material particles with the binder and a step of manufacturing the electrode sheet using the electrode mixture.

### DESCRIPTION

Adding a conduction aid to an electrode sheet such as the one described above allows for improvement in the conductivity of the electrode sheet. The conduction aid is, for example, carbon black or carbon nanotube, and forms conductive pathways extending between active material particles. However, when the active material particles are mixed together with the conduction aid and a binder, the conduction aid may be incorporated into the binder. In this case, the amount of conduction aid extending between the active material particles is reduced, thereby failing to improve the conductivity of the electrode sheet sufficiently.

To avoid the above problem, it is envisioned to reduce the amount of binder to be mixed. However, the reduction in the amount of binder to be mixed may lead to a decrease in the tensile strength of the electrode sheet. Thus, to improve the tensile strength of the electrode sheet, a fibrillatable binder such as polytetrafluoroethylene (PTFE) may be used. However, when the binder is fibrillated, the conductive aid is more likely to be entangled in the binder. As a result, a larger amount of the conduction aid may be incorporated into the binder, further reducing the amount of conduction aid extending between the active material particles.

In view of the above, the disclosure herein provides a technology for improving the conductivity of an electrode sheet while maintaining its tensile strength.

The technology disclosed herein is embodied as a method for manufacturing an electrode sheet. In a first aspect, the method may comprise producing first coated active material particles by mixing first active material particles with at least a binder; producing second coated active material particles by mixing second active material particles with at least a conduction aid; producing an electrode mixture by mixing the first coated active material particles with the second coated active material particles; and forming the electrode mixture into a sheet shape. An average particle diameter of the second active material particles may be larger than an average particle diameter of the first active material particles.

The manufacturing method described above comprises a step of producing the first coated active material particles and a step of producing second coated active material particles. The electrode mixture is produced by mixing the first coated active material particles with the second coated active material particles. In the step of producing the first coated active material particles, the first active material particles and the binder can be mixed together without giving consideration to the effect on the conduction aid. Further, in the step of producing the second coated active material particles, the conduction aid can be adhered to the second active material particles without being affected by the binder. This prevents the conduction aid from being incorporated into the binder when the first coated active material particles and the second coated active material particles are mixed together in the step of producing the electrode mixtures. Thus, a relatively large amount of conduction aid can be used to form conductive pathways between the active material particles without a reduction in the amount of binder to be mixed, allowing for manufacturing of an electrode sheet excellent in both tensile strength and conductivity.

The inventor(s) of the present invention has also found that the particle diameter of the active material particles affects the adherability of the conduction aid (e.g., carbon nanotube) to the active material particles. Specifically, it has been found that the conduction aid is more likely to adhere to active material particles having relatively large particle diameters. Based on this, in the step of producing the second coated active material particles in the manufacturing method above, the conduction aid is mixed with the second active material particles having a relatively large average particle diameter. This allows a larger amount of conduction aid to adhere to the second active material particles, further suppressing the conduction aid from being incorporated into the binder when the first coated active material particles and the second coated active material particles are mixed together.

### BRIEF DESCRIPTION OF DRAWINGS

FIG. 1 schematically shows a configuration of an electrode body 100 in which an electrode sheet 10 is used.

FIG. 2 schematically shows a configuration of the electrode sheet 10.

FIG. 3 shows a flowchart for explaining a manufacturing method of the electrode sheet 10.

FIG. 4 shows a diagram for explaining a step of producing first coated active material particles by mixing PTFE with NCM single crystals using a mixer 104.

FIG. 5 shows a diagram for explaining a step of fibrillating the PTFE by applying a shear force thereto using a kneader 110.

FIG. 6 shows a diagram for explaining a step of forming an electrode mixture into a sheet shape using a press device 116.

FIG. 7A shows a flowchart for explaining a manufacturing method of the electrode sheet 10 according to example 1.

FIG. 7B shows a flowchart for explaining a manufacturing method of an electrode sheet according to comparative example 1.

FIG. 7C shows a flowchart for explaining a manufacturing method of an electrode sheet according to comparative example 2.

FIG. 7D shows a flowchart for explaining a manufacturing method of an electrode sheet according to comparative example 3.

FIG. 8A shows evaluation results of tensile strength for example 1 and comparative examples 1 to 3.

FIG. 8B shows evaluation results of electrical resistance for example 1 and comparative examples 1 to 3.

### DETAILED DESCRIPTION

In a second aspect according to the first aspect, the first active material particles may be monocrystals, and the second active material particles may be polycrystals. This is because the average particle diameter of monocrystals is smaller than that of polycrystals.

In a third aspect according to the first or second aspect, producing the first coated active material particles may comprise fibrillating the binder by applying a shear force to at least the binder. This configuration allows for further improvement in the tensile strength of the electrode sheet.

In a fourth aspect according to any of the first to third aspects, the shear force applied to at least the binder in the fibrillating of the binder is larger than a shear force applied to the second active material particles and the conduction aid in the producing of the second coated active material particles. This configuration allows for improved binding between the first active material particles and the binder in the first coated active material particles. Thus, the tensile strength of the electrode sheet can be improved.

In a fifth aspect according to any of the first to fourth aspects, the conduction aid may comprise at least one component selected from the group consisting of carbon nanotube and acetylene black. The carbon nanotube has a tube shape and the acetylene black has a chain-like structure. Using a conduction aid with such a shape or structure makes it easier for the conduction aid to intertwine with each other and thus facilitates the formation of conductive pathways. On the other hand, a conductive aid having a tube shape or chain structure is easily incorporated into the binder. However, in the present technology, since the conduction aid adheres to the second active material particles in advance in the step of producing the second coated active material particles, the conduction aid is effectively suppressed from being incorporated into the binder.

In a sixth aspect according to any of the first to fifth aspects, the electrode sheet may be a freestanding electrode sheet. This configuration allows for an increase in the energy density of an electrode. A freestanding electrode sheet herein means an electrode sheet that supports itself without the need for a support (e.g., a current collector).

The technology disclosed herein is also embodied as an electrode sheet. The electrode sheet can be manufactured by the manufacturing method described above. For example, in a seventh aspect, the electrode sheet may comprise active material particles; a binder that binds the active material particles together in a sheet shape; and a conduction aid that forms a conductive path extending between the active material particles in the sheet shape. The active material particles may comprise first active material particles and second active material particles. An average particle diameter of the second active material particles may be larger than an average particle diameter of the first active material particles. At least a part of a surface of each first active material particle may be coated by the binder. At least a part of a surface of each second active material particle may be coated by the conduction aid. As described above, the electrode sheet produced by the present technology is excellent in both tensile strength and electrical conductivity.

In an eighth aspect according to the seventh aspect, the first active material particles may be monocrystals. In this case, the second active material particles may be polycrystals.

In a ninth aspect according to the seventh or eighth aspect, the binder may be a fibrillated resin. This configuration allows for further improvement in the tensile strength of the electrode sheet.

In a tenth aspect according to any of the seventh to ninth aspects, the conduction aid may comprise at least one component selected from the group consisting of carbon nanotube and acetylene black. In this configuration, the conduction aid has a tube shape or chain structure, which improves the conductivity of the electrode sheet.

In an eleventh aspect according to any of the seventh to tenth aspects, the electrode sheet may be a freestanding electrode sheet. This configuration allows for an increase in the energy density of an electrode.

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved electrode sheets, as well as methods for manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

With reference to the drawings, an electrode sheet 10 according to an embodiment will be described. The electrode sheet 10 according to the embodiment is used in an electrode body 100. The electrode body 100 is used, for example, as a positive electrode of a lithium-ion secondary battery.

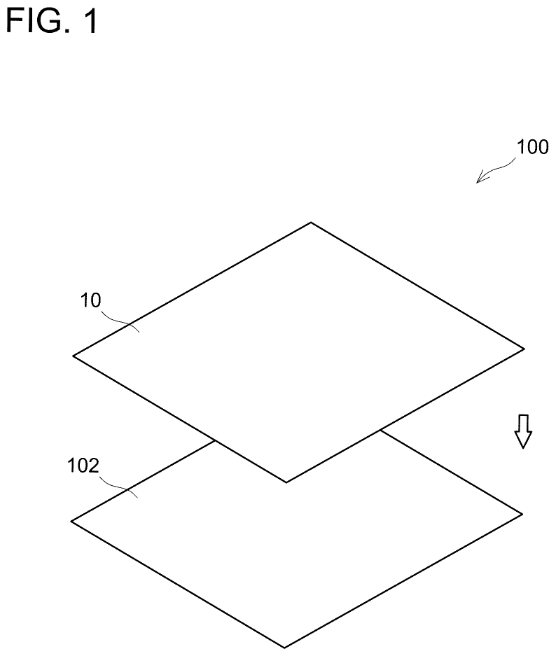

As shown in FIG. 1, the electrode body 100 comprises the electrode sheet 10 and a current collector 102. The current collector 102 is a conductive sheet. The current collector 102 is, for example, an aluminum foil or a copper foil. The thickness of the current collector 102 is, for example, 5 μm or more and 50 μm or less. The electrode sheet 10 is located on the current collector 102. The electrode sheet 10 is a freestanding electrode sheet. A freestanding electrode sheet herein means an electrode sheet that supports itself without requiring a support such as the current collector 102. Thus, the electrode body 100 does not necessarily need to comprise the current collector 102. That is, in another embodiment, the electrode sheet 10 may constitute the electrode body 100 by itself. The thickness of the electrode sheet 10 is, for example, 10 μm or more and 500 μm or less.

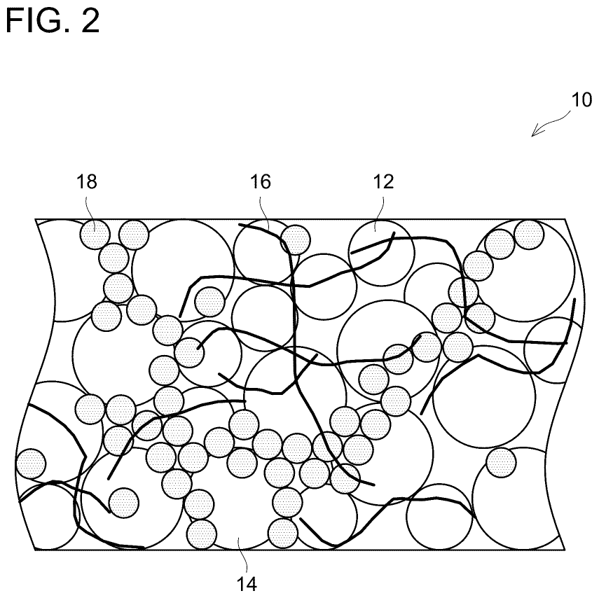

As shown in FIG. 2, the electrode sheet 10 comprises active material particles 12, 14, a binder 16, and a conduction aid 18. The active material particles 12, 14 comprise first active material particles 12 and second active material particles 14. In this embodiment, the first active material particles 12 are monocrystals and the second active material particles 14 are polycrystals. Thus, the average particle diameter of the second active material particles 14 is larger than that of the first active material particles 12. This allows the first active material particles 12 with smaller particle diameter to enter the gaps between the second active material particles 14 with larger particle diameter, thereby improving the electrode density of the electrode sheet 10. At least a part of the surface of each first active material particle 12 is coated by the binder 16. At least a part of the surface of each second active material particle 14 is coated by the conduction aid 18.

The active material particles 12, 14 each are positive-electrode active material particles since the electrode sheet 10 is used as a positive electrode of a lithium-ion secondary battery in this embodiment as described above. Examples of the active material particles 12, 14 include, for example, lithium composite oxides. Examples of the lithium composite oxides include, for example, lithium nickel composite oxides, lithium cobalt composite oxides, lithium manganese composite oxides, lithium nickel manganese composite oxides (e.g., LiNi_{1/2}Mn_{3/2}O₄), lithium nickel manganese cobalt composite oxides (e.g., LiNi_{1/3}Mn_{1/3}Co_{1/3}O₂), and the like. The active material particles 12, 14 may be constituted of a single material or multiple materials. The compound used as the first active material particles 12 may be the same as or different from the compound used as the second active material particles 14.

The binder 16 can bind between the active material particles 12 and 14. Examples of the binder 16 include, for example, carboxymethyl cellulose (CMC), styrene butadiene rubber (SBR), polyvinylidene fluoride (PVdF), polytetrafluoroethylene (PTFE), polyacrylic acid (PAA), acrylic resin, ultra-high molecular weight polyethylene, and the like. The binder 16 may be constituted of a single material or multiple materials. The binder 16 in this embodiment is a fibrillatable resin, and the resin is fibrillated in the electrode sheet 10. A fibrillatable resin herein means a resin that can be fibrillated by a shear force being applied thereto. Examples of the fibrillatable resin include, for example, celluloses, acrylic resins, ultra-high molecular weight polyethylene, and PTFEs.

The conduction aid 18 can form conductive pathways extending between the active material particles 12, 14 in the electrode sheet 10. Examples of the conduction aid 18 include, for example, carbon nanotubes, carbon black (e.g., acetylene black, furnace black, ketjen black, etc.), cokes, and graphite carbon materials. The conduction aid 18 may be constituted of a single material or multiple materials.

The inventor(s) of the invention has found that the particle diameters of the active material particles 12, 14 affect adherability of the conduction aid 18 (e.g., carbon nanotube) to the active material particles 12, 14. Specifically, it has been found that the conduction aid 18 is more likely to adhere to active material particles having relatively large particle diameters. In view of this, in this embodiment, the electrode sheet 10 is manufactured using the active material particles 12 and 14 having different average particle diameters, as described above.

The average particle diameter of the second active material particles 14 is, for example, more than twice the average particle diameter of the first active material particles 12, or more than three times the average particle diameter of the first active material particles 12. The average particle diameter of the first active material particles 12 is not particularly limited, but it is, for example, 0.5 μm or more and 6 μm or less, 1 μm or more and 5 μm or less, or 2 μm or more and 4 μm or less. The average particle diameter of the second active material particles 14 is not particularly limited, but it is, for example, 7 μm or more and 13 μm or less, 8 μm or more and 12 μm or less, or 9 μm or more and 11 μm or less. The average particle diameter herein means particle a particle diameter at 50% integration (D50) in a volume-based particle size distribution measured by the laser diffraction/scattering method.

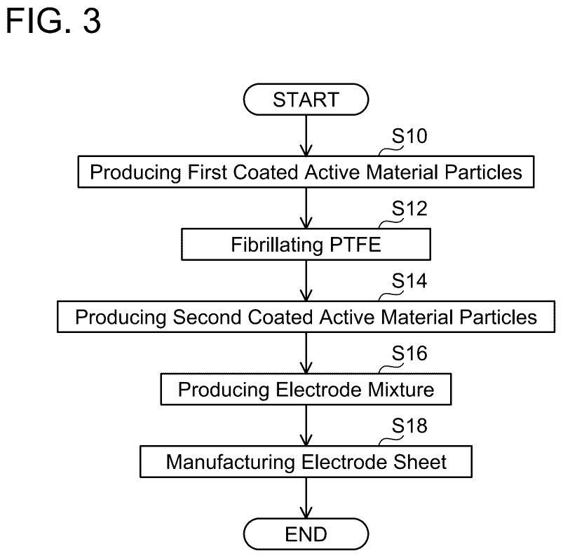

Referring now to FIGS. 3 to 6, a manufacturing method of the electrode sheet 10 will be described. This manufacturing method allows for manufacturing of the electrode sheet 10 without using any solvents. That is, the manufacturing method is a so-called dry process.

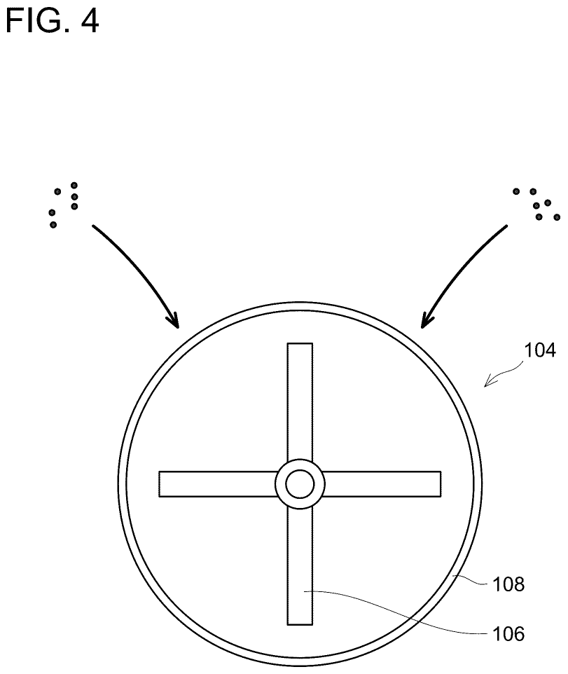

As shown in FIG. 3, the manufacturing method comprises a step of producing first coated active material particles by mixing the first active material particles 12 with the binder 16 (S10). In this step, a mixer 104 is used, for example, as shown in FIG. 4. The mixer 104 mixes the first active material particles 12 and the binder 16 put into a container 108 by rotating a blade 106. Thereby, the first coated active material particles in which the binder 16 is adhering to the first active material particles 12 is produced. That is, in the first coated active material particles, at least a part of the surface of each first active material particle 12 is coated by the binder 16. In this step, in addition to the first active material particles 12 and the binder 16, other necessary materials may be mixed together. However, the conduction aid 18 is not mixed in this step. The absence of the conduction aid 18 allows for the mixing of the first active material particles 12 and the binder 16 without giving consideration to the effect on the conduction aid 18.

In this embodiment, the mixer 104 increases the rotation speed of the blade 106 in stages such that the first active material particles 12 are mixed with the binder 16 at two different rotation speeds. However, the mixer 104 does not necessarily need to increase the rotation speed of the blade 106 in two stages. In another embodiment, the rotation speed of the blade 106 may be constant or increased in three or more stages. In S10, the mixer 104 need not necessarily be used. In other embodiments, another mixer such as a blender, a mill, or the like may be used in place of the mixer 104.

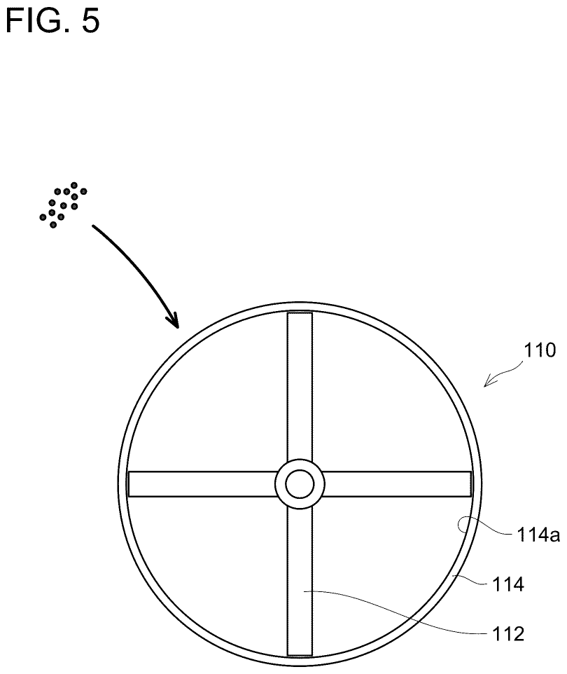

As shown in FIG. 3, the manufacturing method further comprises a step of fibrillating the binder 16 by applying a shear force to the first coated active material particles (S12). In this step, a kneader 110 is used, for example, as shown in FIG. 5. The kneader 110 applies a shear force to the first coated active material particles between a blade 112 and a wall 114a of a container 114 by rotating the blade 112. As described above, since the binder 16 in this embodiment is a fibrillatable resin, the binder 16 is fibrillated by the shear force being applied to the binder 16 which constitutes the first coated active material particles. This allows for further improvement in the tensile strength of the electrode sheet 10. In S12, the kneader 110 need not necessarily be used. In other embodiments, another mixer such as a blender, a mill, or the like may be used in place of the kneader 110. The step S12 may be performed with the container 114 of the kneader heated at a predetermined temperature, although this need not necessarily be the case.

As shown in FIG. 3, the manufacturing method further comprises a step of producing second coated active material particles by mixing the second active material particles 14 with the conduction aid 18 (S14). In this step, a mixer is used, for example, as shown in FIG. 4. The mixer mixes the second active material particles 14 and the conduction aid 18 put into a container by rotating a blade. Thereby, the second coated active material particles in which the conduction aid 18 is adhering to the second active material particles 14 is produced. That is, in the second coated active material particles, at least a part of the surface of each second active material particle 14 is coated by the conduction aid 18. In this step, in addition to the second active material particles 14 and the conduction aid 18, other necessary materials may be mixed together. In this embodiment, PVdF is mixed together, although this is merely an example. The PVdF is an additive for bonding between the second active material particles 14 and the conduction aid 18 during the mixing of the second active material particles 14 and the conduction aid 18. That is, the PVdF used in this step is not intended to bind between the active material particles 12 and 14 in the electrode sheet 10, as the binder 16 used in S10 does. Thus, the amount of PVdF to be mixed is relatively small, and the conduction aid 18 is not incorporated into the PVdF. Materials other than the PVdF may be used as such additives, but fibrillatable resins such as PTFE, for example, should not be used. Also, since the second active material particles 14 have a relatively large average particle diameter, a larger amount of the conduction aid 18 can adhere to the second active material particles 14.

As shown in FIG. 3, the manufacturing method further comprises a step of producing an electrode mixture by mixing the first coated active material particles with the second coated active material particles (S16). In this step, a mixer is used, for example, as shown in FIG. 4. By rotating a blade of the mixer, the first coated active material particles and the second coated active material particles put into a container are mixed together. Thereby, the electrode mixture is produced. Producing the electrode mixture in this manner suppresses the conduction aid 18 from being incorporated into the binder 16, for example, compared to when the electrode mixture is produced by mixing the active material particles 12, 14, the binder 16, and the conduction aid 18 together all at once.

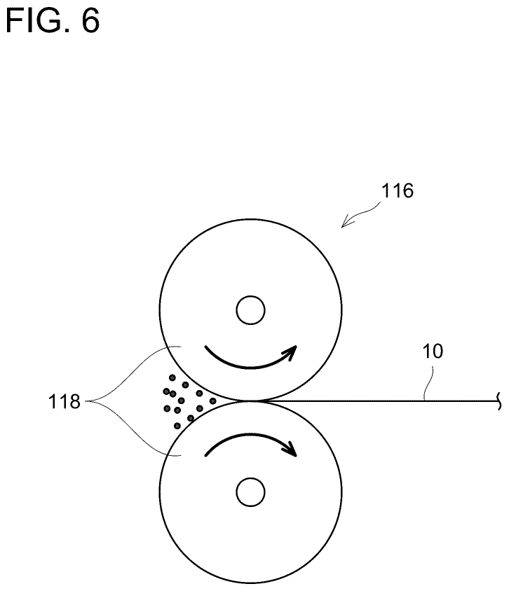

As shown in FIG. 3, the manufacturing method further comprises a step of forming the electrode mixture into a sheet shape (S18). In this step, a press device 116 is used, for example, as shown in FIG. 6. The press device 116 is equipped with a pair of rollers 118 and is configured to roll the electrode mixture while it is passing between the pair of rollers 118. The electrode mixture is thus formed into a sheet shape by being rolled by the pair of rollers 118. Thereby, the electrode sheet 10 is manufactured. As described above, the resulting electrode sheet 10 is a freestanding electrode sheet. The step S18 may be performed with the pair of rollers 118 heated at a predetermined temperature, although this need not necessarily be the case.

According to the manufacturing method described above, a relatively large amount of conduction aid 18 can extend and form conductive pathways between the active material particles 12 and 14 without a reduction in the amount of binder 16 to be mixed, so that the electrode sheet 10 with both excellent tensile strength and conductivity can be manufactured. In addition, since a large amount of conductive aid 18 can adhere to the second active material particles 14 in the step of producing the second coated active material particles (S14), the conductive aid 18 is further suppressed from being incorporated into the binder 16 when the first coated active material particles and the second coated active material particles are mixed.

The content of the first active material particles 12 in the electrode mixture is, for example, 45 weight % or more and 49.5 weight % or less, or 47 weight % or more and 49 weight % or less. The content of the second active material particles 14 in the electrode mixture is, for example, 45 weight % or more and 49.5 weight % or less, or 47 weight % or more and 49 weight % re less. The weight ratio of the content of the first active material particles 12 to the content of the second active material particles 14 in the electrode mixture is, for example, 1.1:1, 1:1, or 1:1.1.

The content of the binder 16 in the electrode mixture is, for example, 0.5 weight % or more and 5 weight % or less, or 1 weight % or more and 3 weight % or less. The content of the conduction aid 18 in the electrode mixture is, for example, 0.25 weight % or more and 3 weight % or less, or 0.5 weight % or more and 2 weight % or less. The content of the additive in the electrode mixture is, for example, 0.1 weight % or more and 2 weight % or less, or 0.25 weight % or more and 1 weight % or less.

In the manufacturing method described above, the shear force applied to the binder 16 in the step of fibrillating the binder 16 (S12) is greater than the shear force applied to the second active material particles 14 and the conduction aid 18 in the step of producing the second coated active material particles (S14). This configuration increases the binding between the first active material particles 12 and the binder 16 in the first coated active material particles. Thus, the tensile strength of the electrode sheet 10 can be improved.

In one example, the conduction aid 18 used in the above manufacturing method comprises at least one component selected from the group consisting of carbon nanotube and acetylene black. The carbon nanotube has a tube shape and the acetylene black has a chain-like structure. Using the conduction aid 18 having such a shape or structure makes it easier for the conduction aid 18 to intertwine with each other and thus facilitates the formation of conductive pathways. On the other hand, a conductive aid 18 having a tube shape or chain structure is easily incorporated into the binder 18. However, in the present technology, since the conduction aid 18 adheres to the second active material particles 14 in advance in the step of producing the second coated active material particle (S14), the conduction aid 18 is effectively suppressed from being incorporated into the binder 16.

Examples related to the present technology will be described below, however, it is not intended to limit the technology to such examples.

### Example 1

### (Preparation of Raw Materials)

As the first active material particles 12, LiCo_{1/3}Ni_{1/3}Mn_{1/3}O₂ monocrystals (hereinafter referred to as NCM monocrystals, average particle diameter: 3 μm) were used. As the second active material particles 14, LiCo_{1/3}Ni_{1/3}Mn_{1/3}O₂ polycrystals (hereinafter referred to as NCM polycrystals, average particle diameter: 10 μm) were used. As the binder 16, powder of polytetrafluoroethylene (PTFE, Chemours Company) was used. As the conduction aid 18, powder of carbon nanotubes (CNT, LG Chem Ltd.) was used. As an additive, powder of polyvinylidene fluoride (PVdF, Arkema S.A.) was used. The weight ratio of NCM monocrystals/NCM polycrystals/PTFE/CNT/PVdF was 48.7/48.7/1.4/0.75/0.5.

### (Production of First Coated Active Material Particles and Fibrillation of PTFE)

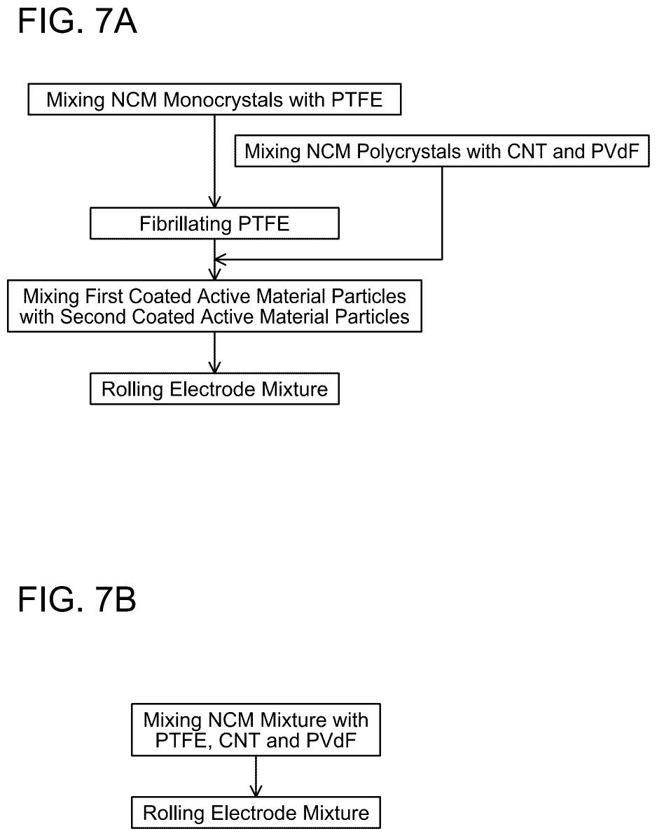

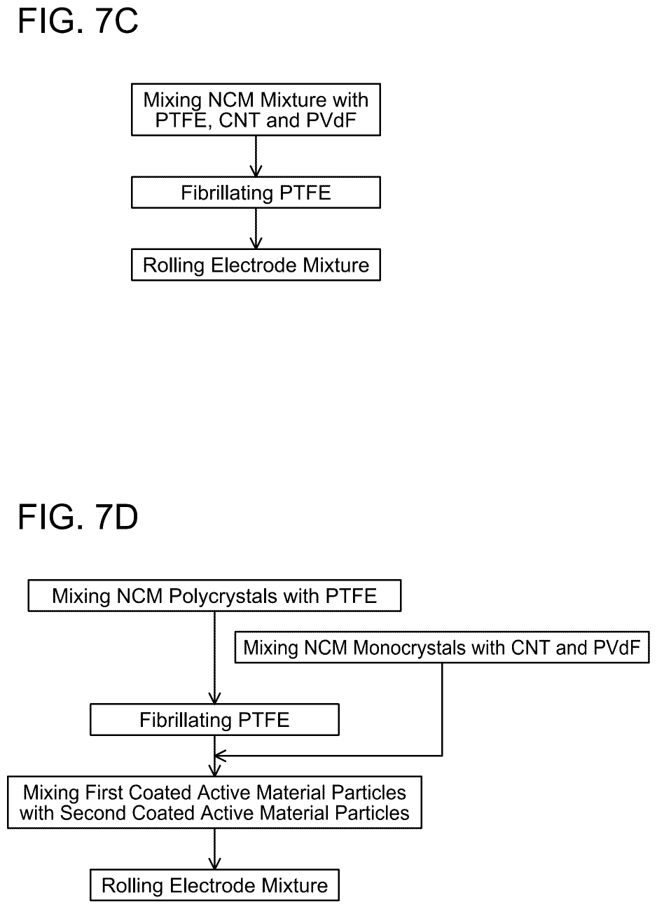

As shown in FIG. 7A, the NCM monocrystals and the PTFE were first put into a mixer (MP5B, Nippon Coke Co., Ltd.) and mixed at 300 rpm for 180 seconds, and then mixed at 5000 rpm for 500 seconds. The first coated active material particles were thereby produced. The first coated active material particles were put into a kneader (DSI-5, Nihon Spindle Manufacturing Co.) and kneaded at 10 rpm for 180 seconds at 100° C. This gave a relatively large shear force to the first coated active material particles, fibrillating the PTFE.

### (Production of Second Coated Active Material Particles)

The NCM polycrystals, the CNT, and the PVdF were put into a mixer (MP5B, Nippon Coke Co., Ltd.) and mixed at 10000 rpm for 10 minutes. The second coated active material particles were thereby produced.

### (Production of Electrode Mixture)

The first coated active material particles and the second coated active material particles were put into a mixer (MP5B, Nippon Coke Co., Ltd.) and mixed at 300 rpm for 1 minute. The electrode mixture was thereby produced.

### (Manufacturing of Electrode Sheet)

The electrode sheet 10 was manufactured by rolling the electrode mixture by a roll press machine (SA-602, Tester Sangyo Co., Ltd.) at 160° C. and linear pressure: 0.4 t/cm. The thickness of the electrode sheet 10 was 110 μm.

### Comparative Example 1

### (Preparation of Raw Materials)

In comparative example 1, the active material particles 12 and 14 were different from those in example 1. Specifically, in comparative example 1, a mixture of the above NCM monocrystals and the above NCM polycrystals (hereinafter referred to as NCM mixture) was used as the active material particles 12 and 14. The other raw materials and weight ratio were the same as those in example 1.

### (From Production of Electrode Mixture to Manufacturing of Electrode Sheet)

In comparative example 1, an electrode mixture was produced by mixing the raw materials at once. That is, as shown in FIG. 7B, the NCM mixture, the PTFE, the CNT, and the PVdF were put into the above-mentioned mixer (MP5B, Nippon Coke Co., Ltd.), mixed at 300 rpm for 180 seconds, and then mixed at 5000 rpm for 500 seconds. The electrode mixture was thereby produced. The method of manufacturing the electrode sheet from the electrode mixture was the same as that in example 1.

### Comparative Example 2

### (From Production of Electrode Mixture to Manufacturing of Electrode Sheet)

Comparative example 2 is the same as comparative example 1 except for the former involves a kneader. That is, as shown in FIG. 7C, the mixture mixed in the mixer in comparative example 1 was put into the above-mentioned kneader and kneaded at 100° C. and 10 rpm for 180 seconds. An electrode mixture was thereby produced. The method of manufacturing the electrode sheet from the electrode mixture was the same as that in example 1.

### Comparative Example 3

### (Preparation of Raw Materials)

In comparative example 3, the active material particles 12 and 14 were different from those in example 1. Specifically, in comparative example 3, the above NCM polycrystals were used as the first active material particles 12, and the above NCM monocrystals were used as the second active material particles 14. The other raw materials and weight ratio were the same as those in example 1.

### (From Production of Electrode Mixture to Manufacturing of Electrode Sheet)

As shown in FIG. 7D, in comparative example 3, the electrode sheet was manufactured in the same way as in example 1.

### Tensile Strength

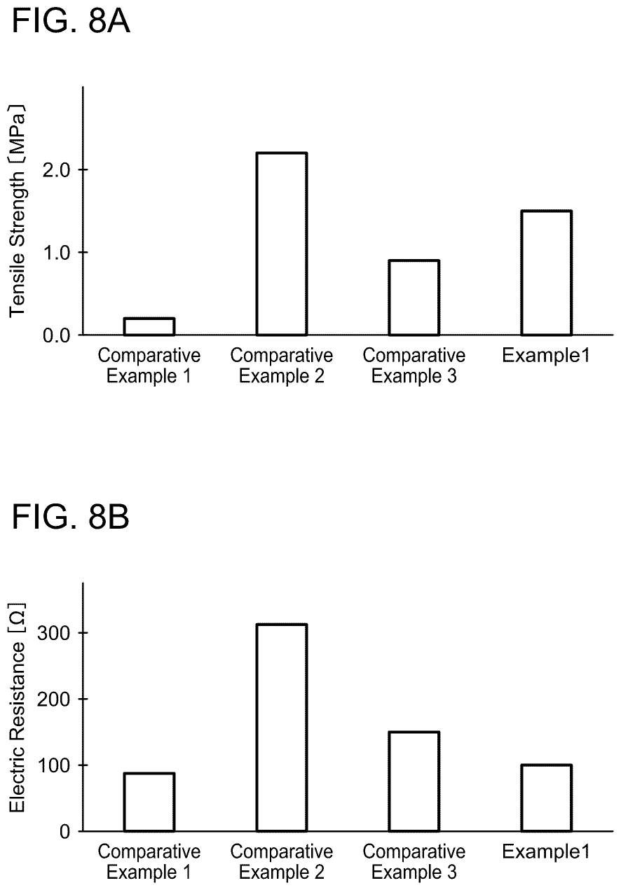

The electrode sheets manufactured by the methods of example 1 and comparative examples 1 to 3 were punched with a punching blade die to produce a dogbone-shaped sample pieces each having 4 mm width. The thickness of the sample pieces was approximately 5.6 mm. Measurement was made using AGS-X, 50N load cell, and 50N clip-type gripper manufactured by Shimadzu Corporation as measurement devices, with a distance between grippers of approximately 4.0 mm and an initial strain rate of 0.33/s (tensile rate 1.3 mm/s). The measurement results are shown in FIG. 8A.

The results shown in FIG. 8A indicate that the tensile strength of the electrode sheet 10 of example 1 is higher than that of the electrode sheet of comparative example 1. The tensile strength of the electrode sheet in comparative example 2 is also higher than that of the electrode sheet in comparative example 1. It can be said that electrode sheets have improved tensile strength when they are made from electrode mixtures that include fibrillated PTFE.

The tensile strength of the electrode sheet in comparative example 3 was lower than those of the electrode sheets in examples 1 and comparative example 2, and was approximately the same as that of the electrode sheet in comparative example 1. That is, the result of comparative example 3 where the kneader was used as in example 1 and comparative example 2 is the same as that of comparative example 1 where a kneader was not used. It can be said that using active material particles with a small average particle diameter (e.g., NCM monocrystals) as the first active material particles 12 and active material particles with a large average particle diameter (e.g., NCM polycrystals) as the second active material particles 14 is advantageous in terms of tensile strength.

### Electrical Resistance

The electrical resistances of the sample pieces (φ11.25 mm) of the electrode sheets made by the methods of example 1 and comparative examples 1 to 3 were measured using an electrode resistance measurement system (RM2610, Hioki E.E. Corporation). The measurement results are shown in FIG. 8B.

The results shown in FIG. 8B indicate that the electrical resistance of the electrode sheet 10 in example 1 is lower than that of the electrode sheet in comparative example 2. It can be said that when PTFE is fibrillated in producing an electrode mixture, mixing NCM monocrystals and PTFE, as well as NCM polycrystals, CNT, and PVdF separately is more advantageous than mixing them together at once in terms of conductivity of the electrode sheet 10. This would be because the CNT is suppressed from being incorporated into the PTFE and a relatively large amount of CNT extends between the NCMs, thus forming sufficient conductive pathways in the electrode sheet 10.

Additionally, the electrical resistance of the electrode sheet of example 1 is lower than that of the electrode sheet of comparative example 3. It can be said that using active material particles with a small average particle diameter (e.g., NCM monocrystals) as the first active material particles 12 and active material particles with a large average particle diameter (e.g., NCM polycrystals) as the second active material particles 14 is more advantageous in terms of the electrode sheet's conductivity. This would be because the CNT more easily adheres to the NCM polycrystals having a relatively large average particle diameter than to the NCM monocrystals having a relatively small particle diameter. The high adherability of CNT to NCM polycrystals with a relatively large particle diameter has been confirmed from SEM-EDS (Scanning Electron Microscope-Energy Dispersive X-ray Spectrometry) images of the electrode sheets.

The above results show that the electrode sheet 10 of example 1 is superior in both tensile strength and electrical conductivity (i.e., electrical resistance) compared to the electrode sheets of comparative examples 1 to 3.

In the embodiment described above, the electrode body 100 is described as being used as the positive electrode of a lithium-ion secondary battery, as an example. However, the technology disclosed herein is not necessarily limited to the positive electrode of a lithium-ion secondary battery and is applicable to an electrode body used as the negative electrode of a lithium-ion secondary battery. In this case, the active material particles 12 and 14 described above may be changed to negative-electrode active material particles. Examples of the negative-electrode active material particles include, for example, carbon materials such as graphite, hard carbon, and soft carbon. The present technology is not limited to lithium-ion secondary batteries and is applicable to electrode bodies of secondary batteries of any types (positive electrode or negative electrode) as well.

In the embodiment described above, the first active material particles 12 are monocrystals and the second active material particles 14 are polycrystals. However, the crystal states of the active material particles 12 and 14 are not particularly limited, as long as the average particle diameter of the second active material particles 14 is larger than that of the first active material particles 12.

In the embodiment described above, as shown in FIG. 3, the method of manufacturing the electrode body 100 comprises the step of fibrillating the binder 16 (S12). However, in a variant, the step of fibrillating the binder 16 may be omitted, and in this case, a non-fibrillatable material may be used for the binder 16.

In the above embodiment, as shown in FIG. 3, in the method of manufacturing electrode body 100, the second coated active material particles are produced (S14) after the first coated active material particles are produced (S10). However, in a variant, the first coated active material particles may be produced after the second coated active material particles are produced. That is, S14 may be performed before S10 in the method of manufacturing the electrode body 100 shown in FIG. 3.

What is claimed is:

1. A method for manufacturing an electrode sheet, comprising:
producing first coated active material particles by mixing first active material particles with at least a binder;
producing second coated active material particles by mixing second active material particles with at least a conduction aid;
producing an electrode mixture by mixing the first coated active material particles with the second coated active material particles; and
forming the electrode mixture into a sheet shape,
wherein an average particle diameter of the second active material particles is larger than an average particle diameter of the first active material particles.

2. The method according to claim 1, wherein
the first active material particles are monocrystals, and
the second active material particles are polycrystals.

3. The method according to claim 1, wherein producing the first coated active material particles comprises fibrillating the binder by applying a shear force to at least the binder.

4. The method according to claim 3, wherein the shear force applied to at least the binder in fibrillating the binder is larger than a shear force applied to the second active material particles and the conduction aid in producing the second coated active material particles.

5. The method according to claim 1, wherein the conduction aid comprises at least one component selected from the group consisting of carbon nanotube and acetylene black.

6. The method according to claim 1, wherein the electrode sheet is a freestanding electrode sheet.

7. An electrode sheet, comprising:
active material particles;
a binder that binds the active material particles together in a sheet shape; and
a conduction aid that forms a conductive path extending between the active material particles in the sheet shape,
wherein the active material particles comprise first active material particles and second active material particles,
an average particle diameter of the second active material particles is larger than an average particle diameter of the first active material particles,
at least a part of a surface of each first active material particle is coated by the binder, and
at least a part of a surface of each second active material particle is coated by the conduction aid.
